(19) United States
(12) Patent Application Publication
(10) Pub. No.: US 2024/0216962 A1
(43) Pub. Date: Jul. 4, 2024

(54) METHOD FOR HANDLING A WATER-SENSITIVE AND/OR TEMPERATURE-SENSITIVE COMPOUND

(71) Applicant: Composite Production Technology B.V., Wieringerwerf (NL)

(72) Inventors: Jordy Van Nimwegen, Haarlem (NL); Pieter Jelle De Jong, Purmerend (NL); Casper Rudolph Johannes Willems, Amsterdam (NL)

(21) Appl. No.: 18/558,953

(22) PCT Filed: May 4, 2022
(86) PCT No.: PCT/EP2022/061990

§ 371 Date: Nov. 3, 2023

(30) Foreign Application Priority Data
May 4, 2021 (NL) 2028138

(51) Int. Cl. B08B 7/00; B08B 9/032

(52) U.S. Cl. CPC B08B 7/0014; B08B 9/0326

(57) ABSTRACT

The present invention provides a method for transport and storage of water-sensitive and/or temperature-sensitive compounds such as isocyanates wherein the compounds can be stored or transported under controlled conditions with ease of removal of the compounds and cleaning afterwards without the risk of damaging the container or pipes. To this end the present invention is directed to a method for handling a water-sensitive and/or temperature-sensitive compound in liquid form wherein the surface of the device that is in contact with the water-sensitive and/or temperature sensitive compound in liquid form is provided with a watersoluble coating, and the coating is solved with water for cleaning the device. The water-soluble coating preferably comprises polyvinyl alcohol.

### CROSS-REFERENCE TO RELATED APPLICATION(S)

This Application is a Section 371 National Stage Application of International Application No. PCT/EP2022/061990, filed May 4, 2022, in English, and further claims priority to Netherlands patent application Ser. No. 2028138, filed May 4, 2021.

### THE FIELD

The present disclosure is directed to a method for transport and storage of water-sensitive and temperature—sensitive compounds in liquid form such as isocyanates, and equipment such as containers and pipes suitable for this method.

### BACKGROUND

Isocyanates are sensitive to water, crystallisation and overheating. Therefore the transport and storage needs to be conducted under water-free atmosphere and at controlled temperature. If one or more of these conditions are compromised polyurea and/or crystallised isocyanates and/or decomposed isocyanates are deposited on the inner walls of the container, pipes or equipment.

In the field these contaminated containers and pipes are cleaned by means of steam heating, followed by mechanical cleaning with water under high pressure or even with grinding equipment or reactive chemicals. It goes without saying that this will often cause damage to the container or pipes. Moreover, when chemicals are used the waste water needs to be handled as chemical waste.

Several publications are directed to methods for removing isocyanate residues from pipes and equipment during isocyanate production. For instance EP-2772528 describes a specific solvent composition comprising a polyol, an inorganic base and an amine. This solvent composition dissolves the isocyanate residue.

U.S. Pat. No. 5,506,301 describes a process for treating an isocyanate distillation residue by treating the residue with a mixture of acidified water with an organic compound such as limonene, limonene oxide, menthoxy acetic acid, menthyl chloroformate or gamma-terpinene, and stirring until the mixture has a pH of 7.

In US 2012/0271067 the isocyanate residue is brought into contact with high pressure and high temperature water and a solvent so as to decompose the isocyanate residue. Publications on isocyanate transport describe tank containers that have been equipped to address the needs of transporting a liquid that can solidify, may be very viscous and readily reacts with water. For instance JP 2002053196 describes a tank container that is divided into a plurality of heating sections which each are provided with heating means and temperature sensors.

CN 210392211 describes a container barrel with an inner polyethylene lining bag for transport of blocked isocyanates.

US 2010/032337 discloses a receptacle or container adapted for the storage and transportation of selected materials or items, including liquid, gel, or solid substances. These selected items or materials can be either hazardous or non-hazardous substances. As used therein, a hazardous substance (or dangerous goods) generally refers to a substance that is potentially toxic or detrimental to human health or the environment. The receptacle or container has a multi-layer construction wherein the inner layer may be form of a material that dissolves or deteriorates when in contact with a suitable solvent such as water or a cleaning composition. This disclosure does not refer to a method for handling water-sensitive or temperature sensitive material, but rather to handling hazardous material such as agrochemicals. Also GB 2237790 is directed to a container for hazardous material.

### SUMMARY

The present invention provides a method for transport and storage of water-sensitive and/or temperature-sensitive compounds such as isocyanates wherein the compounds can be stored or transported under controlled conditions with ease of removal of the compounds and cleaning afterwards without the risk of damaging the container or pipes.

To this end the present invention is directed to a method for handling a water-sensitive and/or temperature-sensitive compound in liquid form wherein the surface of the device that is in contact with the water-sensitive and/or temperature sensitive compound in liquid form is provided with a water-soluble coating, and the coating is solved with water for cleaning the device.

In one aspect the water-sensitive and/or temperature sensitive compound in liquid form is removed from the device in liquid form after handling.

The water-soluble coating preferably comprises polyvinyl alcohol.

The handling may comprise transport, storage, production, and/or purification of the water-sensitive and/or temperature sensitive compound in liquid form.

Examples of the water-sensitive and/or temperature sensitive compounds in liquid form are isocyanates, preferably diisocyanates such as methylene diphenyl diisocyanates or toluene diisocyanates.

Devices referred to may comprise any functional equipment that comes into contact with the compounds handled including containers, tanks, pipes, valves and or a combination hereof.

The water-soluble coating may be removed by solving it in water.

Optionally, prior to solving the water-soluble coating for cleaning the surface that has been in contact with said water-sensitive and temperature-sensitive compound, said surface provided with water-soluble coating is treated with steam.

Any debris resulting present after the removal of the water-sensitive and/or temperature sensitive compound is rinsed out during the removal of the water-soluble coating.

Optionally, the device has been provided with temperature controlling means and means to the compound free of water during the handling.

The present invention is also directed to a device for handling a water-sensitive and/or temperature-sensitive compound in liquid form wherein the device has been provided with temperature controlling means and means to keep the compound free of water during the handling, and wherein the surface of the device that is in contact with the water-sensitive and/or temperature sensitive compound in liquid form is provided with a water-soluble coating, preferably a polyvinyl alcohol coating and its use for handling a water-sensitive and temperature sensitive compound in liquid form.

### DETAILED DESCRIPTION

The present invention is directed to a method for handling a water-sensitive and/or temperature-sensitive compound in liquid form wherein the surface of the device that is in contact with the water-sensitive and/or temperature-sensitive compound in liquid form is provided with a water-soluble coating, and the coating is solved with water for cleaning the device.

With water-sensitive is meant in the context of this description, water-reactive, hygroscopic, dehydratable, crystallizable, or any other physical or chemical phenomena caused by water or moisture that detrimentally affects the compound.

The term temperature-sensitive means in the context of this description temperature changes that detrimentally affect the compound.

In one aspect the water-sensitive and/or temperature-sensitive compound in liquid form is removed from the device in liquid form after handling.

In principle any material that:
Can be applied as a protective coating that is stable under the conditions applied during the handling, and
does not interfere with the compound to be handled,
and of course, is water-soluble under the conditions applied during removal,
   may be used as water-soluble coating. Examples of suitable water-soluble coatings are polyvinyl alcohol and its derivatives such as ethoxylated PVA, celluloses and its derivatives such as carboxy methyl cellulose, methyl cellulose, hydroxyethyl cellulose, hydroxypropyl cellulose, starch, polyglycolic acid, polyethylene glycol, poly pyrrolidone, poly hydroxybutyrate and copolymers or blends thereof.

The water-soluble coating preferably comprises polyvinyl alcohol. It was found that a polyvinyl alcohol-containing coating can be readily applied to the inner side of equipment either from steel, plastic or composite material to form a protective coating. The polyvinyl alcohol-containing coating is resilient to a lot of water-sensitive and/or temperature sensitive compounds. Further the polyvinyl alcohol-containing coating can be readily removed with water without damaging the surface that has been into contact with the water-sensitive and/or temperature sensitive compound. Furthermore, the waste water formed during cleaning solely contains solved polyvinyl alcohol-containing coating, and may be treated as a biodegradable waste water stream.

Suitable polyvinyl alcohol-containing coatings are commercially available in various grades. The solubility of a PVA coating depends on the hydrolyzation degree and its molecular weight. Depending on the handling conditions the proper PVA grade can be chosen. Commonly, PVA with a hydrolyzation degree between 70 and 99% can be used. In order to ensure proper coating and at the same time a proper water-solubility rate upon removal a hydrolyzation degree between 80 and 98% is preferred, more preferably a hydrolysation degree between 85 and 96%, and most preferably a hydrolyzation degree between 90 and 94%, is used. The molecular weight may vary from 10.000 to 150.000 (Mw). Also blends of PVA with other polymers are suitable, such as blends with polyvinyl pyrrolidone, poly ethylene glycol, polylactic acid, polycaprolactone, polyethylene glycol, poly succinic acid may be used as long as the solubility of the resulting coating is satisfactory and does not interfere with the product to be handled. Also copolymers of vinyl acetate and monomers of the polymers mentioned above may be used.

The PVA-containing coating may comprise additives to, for instance, improve the adherence of the coating, the coatability, the mechanical or chemical stability of the coating, or the solubility during cleaning. Any conventional additive may be used herefor, but care must be taken that the waste water remains a biodegradable waste water stream. Suitable additives, may be biodegradable plasticizers, biodegradable anti-foaming agent, surfactants, biocides, etcetera.

The handling may comprise transport, storage, production, and/or purification of the water-sensitive and/or temperature sensitive compound in liquid form.

Examples of the water-sensitive and/or temperature sensitive compound in liquid form are isocyanates, preferably methylene diphenyl diisocyanates or toluene diisocyanates.

Isocyanates are sensitive to water, crystallisation and overheating. With the method according to the present invention these isocyanates may be produced, transported, purified and stored under water-free atmosphere and controlled temperature. If one of the conditions described above are compromised, any polyurea and/or crystallised isocyanates and/or decomposed isocyanates will be deposited on the water-soluble coating and can be removed without damaging the surface of the device that has been in contact with the isocyanates.

Devices referred to may comprise containers, tanks, pipes, valves any other functional equipment that comes into contact with the compounds handled or a combination hereof.

Optionally, the device has been provided with temperature controlling means and means to keep the compound free of water during the handling.

In the transport, production and purification of isocyanates, for instance, it is common to dispose of part of the functional equipment, such as valves, flanges, pipes, manhole covers upon cleaning. With the method and devices according to the invention this is not necessary.

As mentioned above, the water-soluble coating may be removed by solving it in water. The water pressure for solving the coating may vary from about 10-200 bar, preferably between 50-90 bar. Usually a water sprayer with a water pressure of about 70 bar is sufficient. Optionally, water with increased temperature (e.g. to 30-80° C.) is used so as to facilitate and/or accelerate solution of the coating.

Optionally, prior to solving the water-soluble coating for cleaning the surface that has been in contact with said water-sensitive and temperature sensitive compound, said surface provided with water-soluble coating is treated to remove any residual water sensitive and/or temperature sensitive compound. Optimally, a treatment is chosen that solidifies the compound, so as to facilitate removal of the residual compound. For instance, in the case of compounds that react with water to form solids, a treatment with steam or hot water is possible. For the purpose of ease of processing a steam treatment is preferred. One of the advantages of a steam treatment, is that no chemical waste water is formed. This treatment is especially suitable when handling isocyanates. Any residual isocyanates after removal will be hydrolyzed by the steam treatment to form solid polyurea. This solid polyurea debris will be rinsed out during the subsequent solubilization of the water-soluble coating for cleaning.

Depending on the sensitivity of the compound, a suitable treatment of the residual compound can be chosen, such as a heat treatment, a cooling/crystallisation treatment etcetera.

Any debris resulting present after the removal of the water-sensitive and/or temperature sensitive compound or after treatment as described above, is rinsed out during the removal of the water-soluble coating. Large pieces of debris may be removed by hand.

The present invention is also directed to a device for handling a water-sensitive and/or temperature sensitive compound in liquid form wherein the device has been provided with temperature controlling means and means to keep the compound free of water during the handling, and wherein the surface of the device that is in contact with the water-sensitive and/or temperature sensitive compound in liquid form is provided with a water-soluble coating, preferably a polyvinyl alcohol coating and its use for handling a water-sensitive and temperature sensitive compound in liquid form.

The isocyanates are stored and/or transported in a container and or pipe that has been provided with a water-soluble inner polyvinyl alcohol containing coating. After removal of the isocyanates, the container/pipe can readily be cleaned with water at relatively low pressure (about 10 bar). Any residual isocyanates will be hydrolyzed to form solid polyurea. The PVA-containing coating will solve and said solid polyurea and any other deposits are rinsed out. The solids can readily be isolated from the waste water and the waste water can be handled as non-chemical waste water. It was found that the PVA-containing coatings used in the examples do not interfere with the quality of the isocyanates, while the container and/or pipes are protected from the isocyanates. This and the fact that harsh mechanical or chemical cleaning can be omitted, will enhance the containers' and/or pipes' lifespan and safe energy and decrease the CO₂-footprint of the cleaning.

The present invention is further elucidated by means of the following Examples. These examples are for illustrative purposes only and should not be interpreted as being limitative.

### EXAMPLES

### Example 1: Flow Test PVA-Coated Stainless Steel Plate with MDI

A commercially available PVA coating was applied to a stainless steel test specimen. Parts of the specimen were left untreated. After applying the coating, the test specimen was placed in a steel vessel that is partially filled with MDI (Iso-PMDI 92340)

The MDI was pumped onto the test specimen at an outflow speed of 1.65 m/s and a distance of ±3 cm. The outflow speed corresponds to the outflow speed of the dip tube in an MDI tank container, wherein 30 m3 is loaded in one hour.

The pump had a pulsed operation, so the impact of the MDI will in reality be a lot higher. The pump was pumping for 174 hours in total, or 7 days, with a temperature of around 30° C. under ambient air humidity. Over time the MDI thickened.

After the flow test the test specimen was exposed to a steam treatment. The MDI sticking to the surface reacted and hardened. After steaming, the test specimen was cleaned with a pressure water sprayer at 90 bar with water of 10° C.

During the flow test, the PVA coating remained secured on the surface of the specimen. During the steam treatment the residual MDI hardened, but could be removed easily with the pressure water sprayer. At the untreated surface the MDI could not be removed and that surface could not be cleaned properly.

### Example 2: As Example 1, but with a Composite Plate

The test as described in example 1 had been repeated with a glass fibre—vinyl ester composite test specimen instead of the stainless steel test specimen.

The results resemble the results of example 1.

### Example 3: PVA Coated Stainless Steel Tank Vessel

The sample is an actual stainless steel tank container that has been cleaned and dried prior the test.

In the tank different commercial coatings of PVA were applied on the bottom, with each a different water solubility. Once the coating was applied and dried, approximately 60 liters of pMDI type was poured into the tank container, which corresponds with the residual amount of MDI in the tank after transport.

The tank container with the residual MDI was subjected to a steam treatment for approximately 8 hours. Due to temperature and steam the MDI reacted and hardened. Big pieces of hardened MDI were removed by hand. After broom cleaning the tank a standard cleaning program with water was used (100 bar and 70 a 80° C., for 5 minutes) to clean the tank.

After steaming and cleaning, no MDI was left on the steel container tank at the location where the coating had been applied. The steel tank was undamaged

At the location where NO coating was applied, the MDI did not come off after steaming and cleaning with water at 100 bar, 70 a 80° C. for 5 min.

All 3 different types of coatings proved to be effective.

1. A method for handling a water-sensitive and/or temperature sensitive compound in liquid form within a device, wherein a surface of the device that is in contact with the water-sensitive and/or temperature sensitive compound in liquid form is provided with a water-soluble coating, and the coating is solved with water for cleaning the device after handling the water-sensitive and/or temperature sensitive compound in liquid form.

2. The method according to claim 1, wherein the water-sensitive and/or temperature sensitive compound in liquid form is removed from the device in liquid form after handling.

3. The method according to claim 1, wherein the water-soluble coating comprises polyvinyl alcohol.

4. The method according to claim 1, wherein the handling comprises transport, storage, production, and/or purification of the water-sensitive and/or temperature sensitive compound in liquid form.

5. The method according to claim 1, wherein the water-sensitive and/or temperature sensitive compound in liquid form is isocyanate, wherein the isocyanate comprises methylene diphenyl diisocyanate or toluene diisocyanate.

6. The method according to claim 1, wherein the device comprises a container, a tank, a pipe, a valve or any other functional equipment that comes into contact with the compounds handled or a combination hereof.

7. The method according to claim 1, wherein the water-soluble coating is removed by solving it in water.

8. The method according to claim 7, wherein prior to solving the water-soluble coating for cleaning, the surface that has been in contact with said water-sensitive and temperature sensitive compound, said surface provided with water-soluble coating is treated with steam.

9. The method according to claim 1, wherein any debris resulting present after the removal of the water-sensitive and/or temperature sensitive compound is rinsed out during the removal of the water-soluble coating.

10. The method according to claim 1, wherein the device has been provided with temperature controlling means and means to keep the compound free of water during the handling.

11. A device for handling a water-sensitive and/or temperature-sensitive compound in liquid form wherein the device has been provided with temperature controlling means and means to keep the compound free of water during the handling, and wherein a surface of the device that is in contact with the water-sensitive and temperature sensitive compound in liquid form is provided with a water-soluble coating.

12. The device for handling a water-sensitive and/or temperature-sensitive compound in liquid form according to claim 11, wherein the water-soluble coating is a polyvinyl alcohol-containing coating.

13. The device according to claim 11, wherein the device comprises functional equipment, preferably a container, a tank, a pipe, or a valve, or a combination hereof.

14. Use of a device according to claim 11 for handling a water-sensitive and temperature sensitive compound in liquid form.
